(19) United States
(12) Patent Application Publication
(10) Pub. No.: US 2012/0013263 A1
(43) Pub. Date: Jan. 19, 2012

(54) Electronic Operating Device for Gas Discharge Lamps with Reduced Power Loss and Method for Operating the Operating Device

(75) Inventors: Jürgen Fischer, Munich (DE); Walter Limmer, Munich (DE); Maximilian Schmidl, Pullach (DE); Hannes Wagner, Puchheim (DE)

(73) Assignee: OSRAM Gesellschaft mit beschrankter Haftung, Munich (DE)

(21) Appl. No.: 13/159,382

(22) Filed: Jun. 13, 2011

(30) Foreign Application Priority Data
Jun. 11, 2010 (DE) 10 2010 029 981.2

(51) Int. Cl. H05B 41/36

(52) U.S. Cl. 315/219

(57) ABSTRACT

An electronic operating device for a gas discharge lamp having a voltage transformer which converts an input voltage into an intermediate circuit voltage, and an inverter with a lamp inductor and a bridge circuit with at least two switches which converts the intermediate circuit voltage into a lamp voltage, the operating device being designed to adjust the intermediate circuit voltage present between the DC voltage transformer and the inverter to a predetermined value which is dependent on the lamp state. Also disclosed is a method for operating an operating device.

### RELATED APPLICATIONS

This application claims the priority of German application no. 10 2010 029 981.2 filed Jun. 11, 2010, the entire content of which is hereby incorporated by reference.

### FIELD OF THE INVENTION

The invention relates to electronic operating devices for gas discharge lamps having a voltage transformer which converts an input voltage into an intermediate circuit voltage, and an inverter with a lamp inductor and a bridge circuit with at least two switches which converts the intermediate circuit voltage into a lamp voltage.

### BACKGROUND

Operating devices for gas discharge lamps are known which have a voltage transformer and an inverter, the voltage transformer conventionally converting the AC input voltage into a higher DC voltage, the so-called intermediate circuit voltage, which is then converted into an AC voltage by the inverter in order to operate the gas discharge lamp. In the known operating devices, the intermediate circuit voltage is adjusted to a constant value in order to make the regulation of the entire system simple. The intermediate circuit voltage is often 420 V when the input voltage is a 230 V AC voltage, as is conventional in European power supply systems. When operating a gas discharge lamp which has a low lamp voltage, an unnecessarily large amount of power loss is generated since the AC input voltage first needs to be stepped up by the voltage transformer in order then to be stepped down to the lamp voltage by the inverter. Since conventional gas discharge lamps can also have relatively high lamp voltages, depending on the aging state, however, this high intermediate circuit voltage is necessary, however, in order to be able to reliably operate the gas discharge lamp at all operating points and on all lamp voltages.

### OBJECT

One object of the invention is to provide an electronic operating device for a gas discharge lamp with a voltage transformer which converts an input voltage into an intermediate circuit voltage and an inverter with a lamp inductor and a bridge circuit with at least two switches which converts the intermediate circuit voltage into a lamp voltage, said electronic operating device having a relatively low power loss over all operating points.

### SUMMARY

This object is achieved in accordance with one aspect of the invention directed to an electronic operating device for a gas discharge lamp having a voltage transformer which converts an input voltage into an intermediate circuit voltage, and an inverter with a lamp inductor and a bridge circuit with at least two switches which converts the intermediate circuit voltage into a lamp voltage, the operating device being designed to adjust the intermediate circuit voltage present between the DC voltage transformer and the inverter to a predetermined value which is dependent on the lamp state.

In this case, the intermediate circuit voltage is preferably a function of the lamp voltage. When the following applies for the intermediate circuit voltage: U_{ZK}=U_{K}+U_{L}·C, the power loss of the operating device can be reduced in a simple and inexpensive manner. Here, U_{K} is the predetermined value of a voltage interval with respect to the intermediate circuit voltage, U_{L} is the lamp voltage, and C is a predetermined factor.

In an alternative embodiment, the electronic operating device is designed to decrease the intermediate circuit voltage, starting from an upper maximum value, until the lamp voltage just about does not have any restarting peaks. Restarting peaks are excessive increases in voltage which can occur shortly after commutation of the gas discharge lamp 5. In the text which follows, commutation is considered to be the process in which the polarity of the voltage changes and in which a considerable change in current or voltage takes place. Given a substantially symmetrical mode of operation of the lamp, the voltage or current zero crossing is in the middle of the commutation time. In this case, it should be noted that the voltage commutation generally always takes place more quickly than the current commutation. It is possible with this measure to minimize the power loss, but this measure is more complex in terms of implementation.

In a further embodiment, the operating device can be designed to adjust the intermediate circuit voltage such that it is greater than the lamp voltage by a predetermined value. This measure can be implemented in a simple and therefore inexpensive manner.

In a further embodiment, the operating device can be designed to adjust the intermediate circuit voltage such that it is greater than the lamp voltage by a predetermined value but is not less than the input voltage plus a second predetermined value. This measure can also be implemented in a simple and inexpensive manner.

In a further embodiment, the intermediate circuit voltage is a function of the lamp current. This measure can also be implemented in an inexpensive manner since the lamp current is already measured for other reasons in conventional topologies.

In a further embodiment, the electronic operating device can be designed to decrease the intermediate circuit voltage, starting from an upper maximum value, until the lamp current profile just about does not have any dips. This requires a relatively complex measurement method, but it is possible with this mode of operation to minimize the power loss in the operating device.

The operating device can be designed to increase the value of the intermediate circuit voltage with respect to the lamp voltage following unforeseen extinguishing of the lamp. This measure increases operational reliability in the case of lamps which are difficult to operate.

Furthermore, the operating device can increase the value of the intermediate circuit voltage to the predetermined maximum value following unforeseen extinguishing of the lamp. This measure maximizes operational reliability in the case of problematic lamps at the expense of the power loss. Preferably, the voltage transformer has the function of a power factor correction circuit.

The bridge circuit of the operating device is preferably a half-bridge circuit. The half-bridge circuit has the advantage of fewer component parts, but does require double the intermediate circuit voltage and therefore increases the losses in the electronic operating device. The bridge circuit can therefore likewise be a full-bridge circuit. A full-bridge circuit has the advantage of the intermediate circuit voltage required being lower and can therefore reduce the losses.

Further advantageous developments and configurations of the operating device according to the invention result from the further dependent claims and from the description below.

### BRIEF DESCRIPTION OF THE DRAWINGS

Further advantages, features and details of the invention result from the description below relating to exemplary embodiments and from the drawings, in which identical or functionally identical elements have been provided with identical reference symbols and in which:

FIG. 1 shows a circuit diagram of a first embodiment of the electronic operating device according to the invention with a full-bridge circuit and resonance starting; and

FIG. 2 shows a circuit diagram of a second embodiment of the electronic operating device according to the invention with a half-bridge circuit and pulsed starting.

### DETAILED DESCRIPTION OF THE DRAWINGS

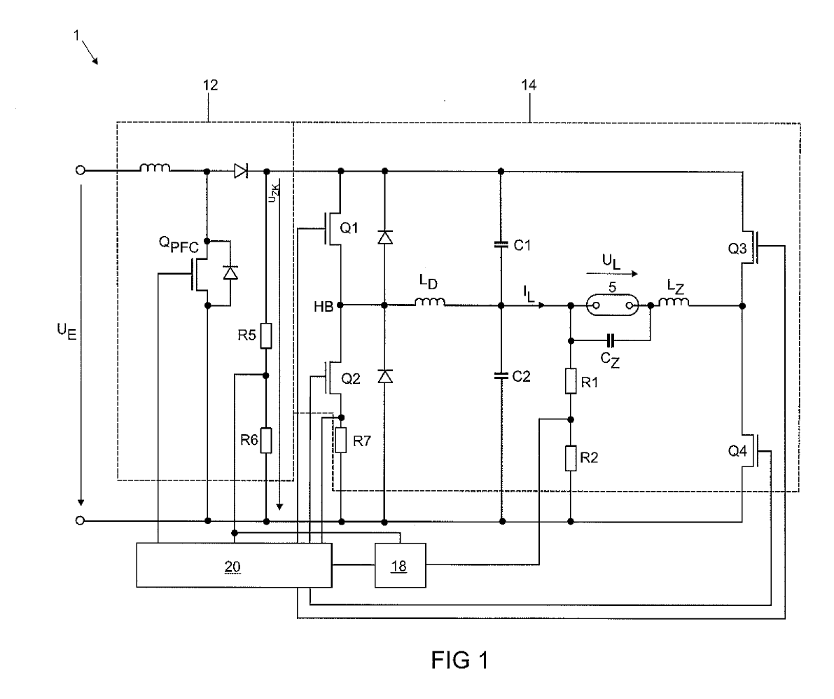

FIG. 1 shows a schematic illustration of the design of a first embodiment of the circuit arrangement according to the invention with a full-bridge circuit and resonance starting. The system input voltage U_{E} is converted into a DC voltage, the so-called intermediate circuit voltage U_{ZK}, in a voltage transformer. The voltage transformer 12 has the function of a power factor correction circuit. The power factor correction circuit is controlled by a control device 20. For this purpose, a voltage divider comprising two resistors R5 and R6 is connected between the intermediate circuit voltage and the reference potential, said voltage divider inputting a measured value, which represents the intermediate circuit voltage, into the control device 20 and into a voltage measurement device 18. An inverter 14 is connected to the power factor correction circuit. The inverter has a full-bridge arrangement with two pairs of switches Q1, Q2 and Q3, Q4. A first switch Q1 and a second switch Q2 form a half-bridge, and a third switch Q3 and a fourth switch Q4 form a half-bridge. In this case, the intermediate circuit voltage U_{ZK} is present at the two pairs of switches. Depending on the embodiment, this intermediate circuit voltage is approximately 200 V to 500 V and is generated by the power factor correction circuit. The full-bridge center point HB is connected to a first terminal of the lamp 5 via a lamp inductor L_{D}. Moreover, two capacitors C₁ and C₂ are connected to this terminal, said capacitors, in a first embodiment, being designed, together with the lamp inductor L_{D}, to smooth the current flowing through the lamp. The current flowing through the lamp is denoted by I_{L}, and the voltage drop across the lamp is denoted by U_{L}. The other terminal of the lamp 5 is connected firstly to the intermediate circuit voltage U_{ZK} (via the third switch Q3 and secondly to a reference potential, in this case ground, via the fourth switch Q4. The first lamp terminal is connected to the reference potential via a first voltage divider comprising the resistors R1 and R2. The tap of the voltage divider is connected to the voltage measurement device 18 for measuring the actual value of the voltage U_{L} across the high-pressure discharge lamp 5 for determining a voltage, which is correlated with the lamp voltage U_{L}. The control device 20 is designed to switch the first and fourth switching transistors Q1, Q4 and the second and third switching transistors Q2, Q3 in the first bridge circuit alternately on and off at a first frequency and, during the off phase of one pair of switches Q1, Q4, to drive a switch Q2 from the other pair of switches Q2, Q3 with a square-wave signal of a second frequency, which is higher than the first frequency, and with a predeterminable switch-on duration. In the off phase of the other pair of switches Q2, Q3, on the other hand, a switch Q1 from one pair of switches Q1, Q4 is driven with a square wave signal of a second frequency, which is higher than the first frequency, and with a predeterminable switch-on duration. Thus, the AC voltage at the full-bridge center point HB is lower than the input voltage U_{ZK} of the inverter 14. The control device 20 is furthermore designed to drive the switching transistor Q_{PFC} in such a way that the intermediate circuit voltage U_{ZK} can be set. For this purpose, a further voltage divider comprising the resistors R5 and R6 is provided, said voltage divider being connected between the intermediate circuit voltage U_{ZK} and the reference potential.

The lamp voltage U_{L} is measured as follows: When the switches Q1 and Q4 are closed and the switches Q2 and Q4 are open, one terminal is connected to the potential of the intermediate circuit voltage via the inductor L_{D} while the other terminal of the gas discharge lamp 5 is connected to reference potential. The lamp voltage U_{L} can thus be measured directly by the first voltage divider comprising the resistors R1 and R2. When the switches Q2 and Q3 are closed and the switches Q1 and Q4 are open, one terminal of the gas discharge lamp 5 is connected to reference potential via the inductor L_{D} and the other terminal of the gas discharge lamp 5 is connected to the potential of the intermediate circuit voltage. The lamp voltage U_{L} is now calculated from the difference between the intermediate circuit voltage, which is measured by the voltage divider comprising R5 and R6, and the voltage at the first voltage divider comprising R1 and R2.

The control device 20 now performs a correlation of the lamp voltage U_{L} with the intermediate circuit voltage U_{ZK}. The intermediate circuit voltage U_{ZK} is decreased as the lamp voltage decreases and increased as the lamp voltage increases. The dependency can be a linear function, such as U_{ZK}=U_{K}+U_{L}·C, for example, where U_{K} is the predetermined value for a voltage interval between the intermediate circuit voltage and the lamp voltage. U_{K} is generally between 280 V and 320 V. C is a constant, predetermined factor which is dependent on the lamp type, the input voltage and the precise circuit topology. In the present embodiment, C can vary between 0.8 and 1.2. Depending on the embodiment of the input voltage transformer and the working range of the input voltage, it may additionally be necessary for the intermediate circuit voltage U_{ZK} to always be kept greater than the input voltage by a minimum value. When, in the case of a low lamp voltage, the intermediate circuit voltage is decreased, the inverter 14 generates fewer losses given the same output current since it needs to convert from a lower output voltage. At the same time, the DC voltage transformer 12 does not need to increase the output voltage to the same extent, which likewise causes fewer losses. If extinguishing of the lamp should occur during operation, the control device can be designed to increase the input value for the intermediate circuit voltage by a specific amount or else to set the intermediate circuit voltage to the maximum value in order to counteract the extinguishing of the lamp.

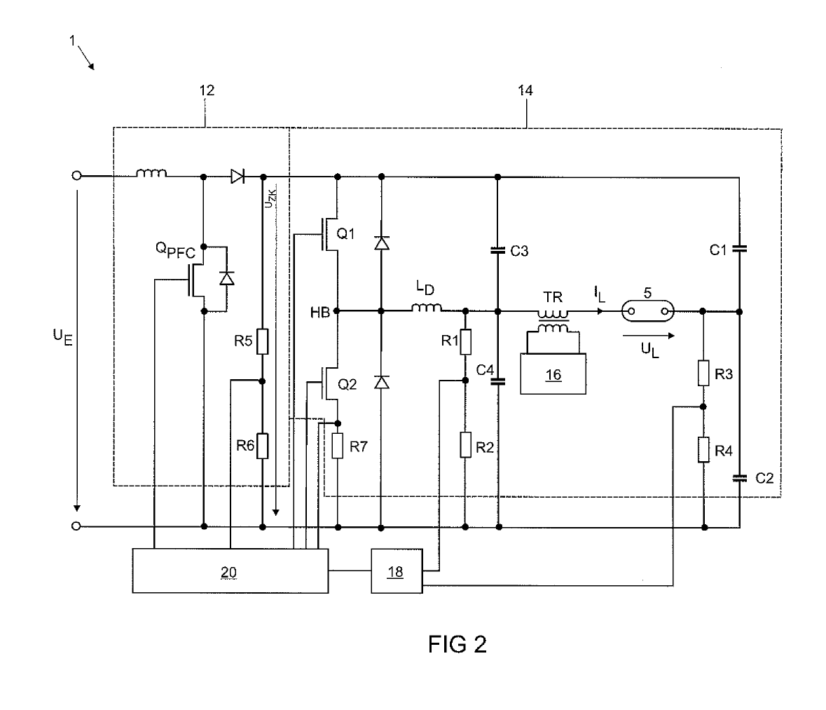

FIG. 2 shows a schematic illustration of the design of a second embodiment of the circuit arrangement according to the invention. The second embodiment is similar to the first embodiment, and therefore only the differences in relation to the first embodiment are described. The second embodiment is equipped with a half-bridge and pulsed starting, in contrast to the first embodiment. The system input voltage U_{E} is converted into a DC voltage U_{ZK} in a voltage divider. The voltage divider 12 has the function of a power factor correction circuit. The power factor correction circuit is controlled by a control device 20. An inverter 14 is connected to the power factor correction circuit. The inverter has a half-bridge arrangement with two switches Q1, Q2. In this case, the intermediate circuit voltage U_{ZK} is present at the two switches Q1, Q2 in the half-bridge arrangement. The half-bridge center point HB is connected to a first terminal of the lamp 5 via a lamp inductor L_{D} and a starting transformer TR. Two capacitors C₁ and C₂ are connected to the other terminal of the gas discharge lamp 5, said capacitors forming the feedback for the current flowing through the lamp in this embodiment. This current is denoted by I_{L}, and the voltage drop across the lamp is denoted by U_{L}. The first lamp terminal is connected to the reference potential via the starting transformer TR and a first voltage divider comprising the resistors R1 and R2, and the second terminal of the lamp 5 is connected to the reference potential via a second voltage divider comprising the resistors R3 and R4. The respective taps of the two voltage dividers are connected to a voltage measurement device 18 for measuring the actual value of the voltage U_{L} across the high-pressure discharge lamp 5 for determining a voltage, which is correlated with the lamp voltage U_{L}. The control device 20 is designed to switch the first and second switching transistors Q1, Q2 alternately on and off at a first frequency and, during the off phase of one switch Q1, to drive the other switch Q2 with a square-wave signal of a second frequency, which is higher than the first frequency, and with a predeterminable switch-on duration. On the other hand, in the off phase of the other switch Q2, the switch Q1 is driven with a square-wave signal of a second frequency, which is higher than the first frequency, and with a predeterminable switch-on duration. Thus, the AC voltage at the half-bridge center point HB is lower than the input voltage U_{ZK} of the inverter 14. The control device 20 is furthermore designed to drive the switching transistor Q_{PFC} in such a way that the intermediate circuit voltage U_{ZK} can be set. For this purpose, as in the first embodiment, a further voltage divider comprising the resistors R5 and R6 is provided which is connected between the intermediate circuit voltage U_{ZK} and the reference potential.

The second embodiment, in contrast to the first embodiment, is equipped with pulsed starting, and not with resonant starting. Therefore, the secondary winding of the starting transformer TR is connected in series with the lamp inductor L_{D} from the first embodiment. The primary winding is connected to a starting device 16, which feeds the starting energy into the starting transformer on the primary side in order to generate a starting pulse. The pulsed starting which has just been described is often also referred to as superimposition starting.

Alternatively, all other conventional circuit topologies with an intermediate circuit are suitable for implementing the described method. Examples of known circuit topologies are a sepic converter as the power factor correction circuit with a full-bridge downstream or a step-up converter as the power factor correction circuit with a half-/full-bridge downstream.

The proposed method would also be advantageous for an operating device for operating DC voltage lamps. Such an operating device would no longer have an inverter but would now only have a DC voltage transformer.

In the exemplary embodiment, a gas discharge lamp 5 has been used which has a lamp voltage of 85 V. Generally, the intermediate circuit voltage U_{ZK} is 420 V in European devices at 230 V. Given a lamp voltage of 85 V, it is acceptable to lower the intermediate circuit voltage U_{ZK} to 380 V. The following table shows the effect of lowering the intermediate circuit voltage on the power loss P_{V}:

| U_{ZK} | U_{L} | P_{V} |
|---|---|---|
| 420 V | 85.7 V | 6.29 W |
| 400 V | 85.7 V | 6.06 W |
| 380 V | 85.7 V | 5.91 W |

Thus, the power loss is reduced by 6% when lowering the intermediate circuit voltage from 420 V to 380 V. This reduction in the power loss causes a reduction in the intrinsic heating by approximately 3□C in the case of an average electronic operating device. Such a reduction results, for example, in an extension of the life of electrolyte capacitors installed there of 25%.

In order to minimize the power loss, another method for regulating the intermediate circuit voltage can also be used instead of a predetermined linear voltage interval. For this purpose, the measurement device should be designed to be able to identify restarting peaks in the lamp voltage. If this is the case, the control device 20 can lower the lamp voltage to such an extent that just about no more restarting peaks occur in the lamp voltage. Restarting peaks are excessive increases in voltage which can occur shortly after the commutation of the gas discharge lamp 5. Restarting peaks arise as a result of an increased demand for voltage owing to excessively cold electrodes or owing to the incapacity of the operating device to provide sufficient current.

The restarting peaks are manifested in high, narrow voltage pulses at the start of the square-wave voltage and can be identified by suitable measurement circuits.

In order to minimize the power loss, a further method for regulating the intermediate circuit voltage can also be used. In this further method, the intermediate circuit voltage is a function of the lamp current.

The intermediate circuit voltage is reduced precisely to the extent that no dips in the lamp current can be established during operation of the lamp. The current should be constant within the individual square-wave phases (and therefore in sections) and should not have any sudden changes, except during the commutation. If the current profile exhibits irregularities, the intermediate circuit voltage is raised slightly again until the current profile is constant again, in sections.

By virtue of this method, the intermediate circuit voltage is kept to a level which is as low as possible in order to be able to operate the gas discharge lamp reliably. The losses of the operating device are minimized in the process.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

1. An electronic operating device for a gas discharge lamp comprising:
a voltage transformer which converts an input voltage into an
intermediate circuit voltage; and
an inverter with a lamp inductor and a bridge circuit with at least two switches which converts the intermediate circuit voltage into a lamp voltage,
wherein the operating device is configured to adjust the intermediate circuit voltage present between the DC voltage transformer and the inverter to a predetermined value which is dependent on the lamp state.

2. The electronic operating device as claimed in claim 1, wherein the intermediate circuit voltage is a function of the lamp voltage.

3. The electronic operating device as claimed in claim 2, wherein the following applies for the intermediate circuit voltage: U_{ZK}=U_{K}+U_{L}·C, where U_{K} is the predetermined value of a voltage interval with respect to the intermediate circuit voltage, U_{L} is the lamp voltage, and C is a predetermined factor.

4. The electronic operating device as claimed in claim 2, wherein the electronic operating device is configured to decrease the intermediate circuit voltage, starting from an upper maximum value, until the lamp voltage just about does not have any restarting peaks.

5. The electronic operating device as claimed in claim 2, wherein the operating device is configured to adjust the intermediate circuit voltage such that it is greater than the lamp voltage by a predetermined value.

6. The electronic operating device as claimed in claim 2, wherein the electronic operating device is configured to adjust the intermediate circuit voltage such that it is a function of restarting peaks of the lamp voltage.

7. The electronic operating device as claimed in claim 1, wherein the electronic operating device is configured to adjust the intermediate circuit voltage such that it is a function of the lamp current.

8. The electronic operating device as claimed in claim 7, wherein the electronic operating device is configured to decrease the intermediate circuit voltage, starting from an upper maximum value, until the lamp current profile just about does not have any dips.

9. The electronic operating device as claimed in claim 1, wherein the operating device is configured to increase the value of the intermediate circuit voltage with respect to the lamp voltage following unforeseen extinguishing of the lamp.

10. The electronic operating device as claimed in claim 1, wherein the operating device increases the value of the intermediate circuit voltage to the predetermined maximum value following unforeseen extinguishing of the lamp.

11. The electronic operating device as claimed in claim 1, wherein the voltage transformer has the function of a power factor correction circuit.

12. The electronic operating device as claimed in claim 1, wherein the bridge circuit is a half-bridge circuit.

13. The electronic operating device as claimed in claim 1, wherein the bridge circuit is a full-bridge circuit.

14. A method for operating an electronic ballast, which has a voltage transformer and an inverter, the electronic operating device being configured to operate a gas discharge lamp, wherein the operating device is configured to adjust an intermediate circuit voltage present between the DC voltage transformer and the inverter to a predetermined value which is dependent on the lamp state.
